(19) United States
(12) Patent Application Publication
(10) Pub. No.: US 2004/0190631 A1
(43) Pub. Date: Sep. 30, 2004

(54) PES data processing

(76) Inventors: Girish Hulmani, Bangalore (IN); Syed Mohammed Ali, Bangalore (IN); Arul Thangaraj, Bangalore (IN); Sandeep Bhatia, Bangalore (IN); Pramod Chandriah, Bangalore (IN)

Correspondence Address: MCANDREWS HELD & MALLOY, LTD, 500 WEST MADISON STREET, SUITE 3400, CHICAGO, IL, 60661

(21) Appl. No.: 10/610,246

(22) Filed: Jun. 30, 2003

Related U.S. Application Data
(60) Provisional application No. 60/459,025, filed on Mar. 31, 2003.

(51) Int. Cl. H04N 7/12

(52) U.S. Cl. 375/240.26

(57) ABSTRACT

A system and method for detecting packetized elementary stream (PES) packet headers is presented herein. PES packet headers are detected by a combination of hardware and firmware. Hardware logic is used to detect the PES start codes while multithreaded firmware us used to process the packet.

### PRIORITY CLAIM

This claims priority to “DirecTV PES Detection”, Provisional Application for U.S. Patent, Serial No. 60/459,025, by Girish Hulmani, filed Mar. 31, 2003, which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The output of an MPEG Audio or Video Encoder is called an elementary stream. An elementary stream is a compressed representation of the audio or video source and may be broken into data blocks of manageable size, forming a packetized elementary stream (PES). The data blocks, known as PES packets, include PES header information to identify the start of the packets. Additionally, the packets also include time stamps, known as presentation time stamps (PTS) and decode time stamps (DTS), because packetization can disrupt synchronization.

For transmission and digital broadcasting, several programs and their associated PES can be multiplexed into a single transport stream. Program Stream comprises of several PES streams with a program header at the beginning. A DirecTV transport packet is a special type of transport packet comprising 130 bytes. Additionally, transport streams can carry multiple programs encoded with different clocks.

While the PES stream is packetized into 130 byte DirecTV transport packets, PES packets do not have a fixed length. PES headers can start anywhere and any number of times within a 130-byte transport packet. Additionally, PES headers can also straddle across 130-byte transport packet boundaries. The foregoing makes PES header detection complex.

Some systems implement PES header detection in firmware. Implementation of PES header detection in firmware consumes significant processor bandwidth, thus limiting the bit rate handling capability of the video transport processor.

Alternatively, PES header detection can be handled in hardware. However, PES header detection in hardware is unable to detect PES headers that straddle transport packets. Accordingly, detection of PES headers that straddle transport packets is still handled in firmware.

Further limitations and disadvantages of convention and traditional approaches will become apparent to one of skill in the art, through comparison of such systems with embodiments of the present invention as set forth in the remainder of the present application with reference to the drawings.

### BRIEF SUMMARY OF THE INVENTION

A system, method, and apparatus for detection of PES headers are presented herein. In one embodiment, there is presented a system for processing DirecTV packets comprising state logic for detecting packet headers associated with the packets, a processor for loading contexts responsive to the state logic detecting the packet headers, and a buffer for storing the packets.

In another embodiment, there is presented a system for processing DirecTV packets comprising state logic for detecting a packet header associated with a packet, and a processor for loading a context associated with the packet, wherein the processor loads a first context if the packet is in a first group and wherein the processor loads a second context if the packet is in a second group.

In another embodiment, there is presented a method for processing DirecTV packets by detecting packet headers associated with the packets, loading contexts responsive to the detecting the packet headers, and storing the packets.

In another embodiment, there is presented a method for processing DirecTV packets by detecting a packet header associated with a packet, loading a first context if the packet is in a first group, and loading a second context if the packet is in a second group.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary transport stream in accordance with an embodiment of the present invention;

FIG. 2 is a block diagram of an exemplary video decoder in accordance with an embodiment of the present invention;

FIG. 3 is a block diagram of an exemplary video transport processor in accordance with an embodiment of the present invention;

FIG. 4 is a block diagram of an exemplary packet identification context table in accordance with an embodiment of the present invention; and

FIG. 5 is a flow diagram for processing a packetized elementary stream in accordance with an embodiment of the present invention.

### DETAILED DESCRIPTION OF THE INVENTION

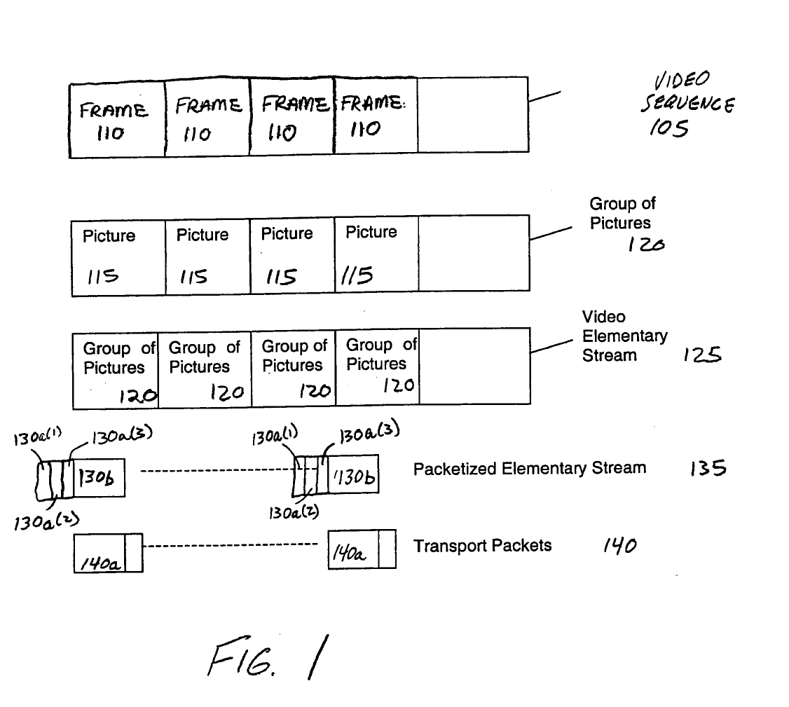

Referring now to FIG. 1, there is illustrated a block diagram describing MPEG formatting of a video sequence 105. A video sequence 105 comprises a series of frames 110. In a progressive scan, the frames 110 represent instantaneous images, while in an interlaced scan, the frames 110 comprise two fields each of which represent a portion of an image at adjacent times. Each frame is represented by a data structure known as a picture 115. The pictures 115 are then grouped together as a group of pictures 120. Groups of pictures 120 are then stored, forming what is known as a video elementary stream 125.

The video elementary sequence 125 is then broken into variable size segments that are packetized, forming packetized elementary stream (PES) packets 130. Each PES packet 130 includes a PES header 130a, and a payload 130b. The PES header 130a comprises several fields, including a PES start code 130a(1), a stream identifier (stream_id) 130a(2), and a packet length 130a(3) which indicates the length of the packet. If the packet length is zero, then the video PES is unbounded, the start of next PES determines the end of current PES. This is valid for video PES only.The payload 130b comprises a particular segment of the video elementary stream 125a. The PES packets 130 together form a PES 135.

A video PES 135 can have a number of audio PESs 135 and data PESs 135, associated therewith. For example, a movie can be represented by a video PES 135, two audio PESs 135 representing stereo signals, and a data PESs 135 for providing subtitles. A program stream is a PES packet 130 multiplex that along with a program header carries multiple PESs that were encoded using the same master clock or system time clock.

Any number of programs can be multiplexed together for transport over a transmission over a communication channel. Each program may use a different compression factor and bit rate that can change dynamically even though the overall bit rate stays constant. The foregoing is known as statistical multiplexing. A decoder must be able to change from one program to the next and correctly select the appropriate audio and data channels.

The PES 135 is then broken into fixed length segments. In DirecTV, the fixed length is 130 bytes. Each fixed length segment forms a payload 140a portion of a DirecTV transport packet 140. The DirecTV transport packet 140 also includes a three byte header 140b with various parameters. Among the parameters is SCID 140b(1) that distinguishes different types of packets. In a given transport stream, all packets belonging to a given elementary stream will have the same SCID number. The transport packets 140 are transported over a communication channel for decoding by a decoder.

While the PES stream is packetized into 130 byte transport packets, PES packets 130 do not have a fixed length. PES headers can start anywhere and any number of times with a 130-byte transport packet. Additionally, PES headers can also straddle across 130-byte transport packet boundaries.

The PES header detection can be accomplished by a combination of hardware and software. The hardware can be used to detect PES start codes 130a(1), while a processor executing instructions in software can process detected PES packets. The processor can handle multiple different PES by processing each PES as a separate thread. When the hardware detects a PES start code 130a(1), the hardware interrupts the processor. Responsive to the interrupt, the processor processes the PES packet 130 until the end of the PES packet.

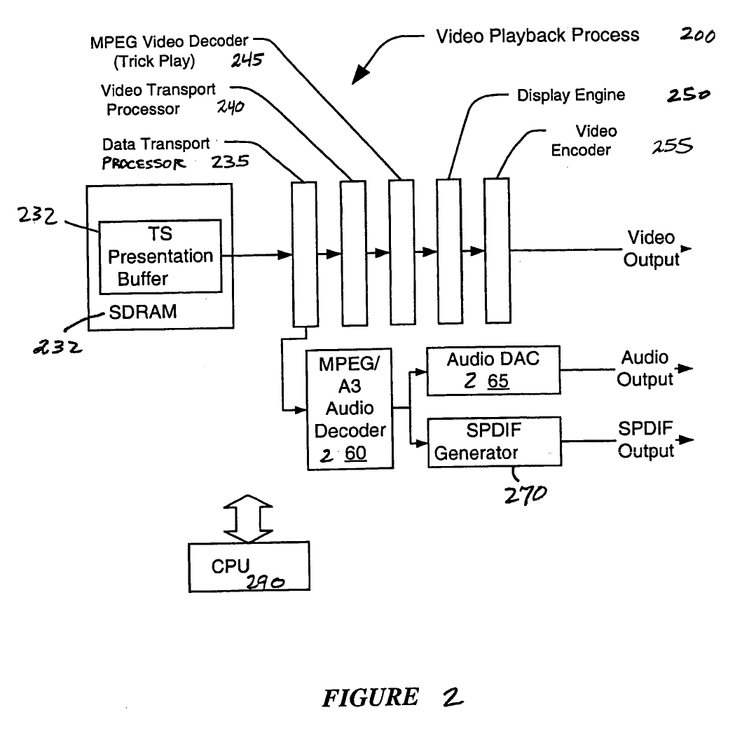

Referring now to FIG. 2, there is illustrated a block diagram of an exemplary decoder in accordance with an embodiment of the present invention. Data is output from buffer 232 within SDRAM 230. The data output from the presentation buffer 232 is then passed to a data transport processor 235. The data transport processor 235 demultiplexes the transport stream into packetized elementary stream constituents, and passes the audio transport stream to an audio decoder 260 and the video transport stream to a video transport decoder 240 and then to a MPEG video decoder 245. The audio data is then sent to the output blocks, and the video is sent to a display engine 250. The display engine 250 scales the video picture, renders the graphics, and constructs the complete display. Once the display is ready to be presented, it is passed to a video encoder 255 where it is converted to analog video using an internal digital to analog converter (DAC). The digital audio is converted to analog in an audio digital to analog (DAC) 265.

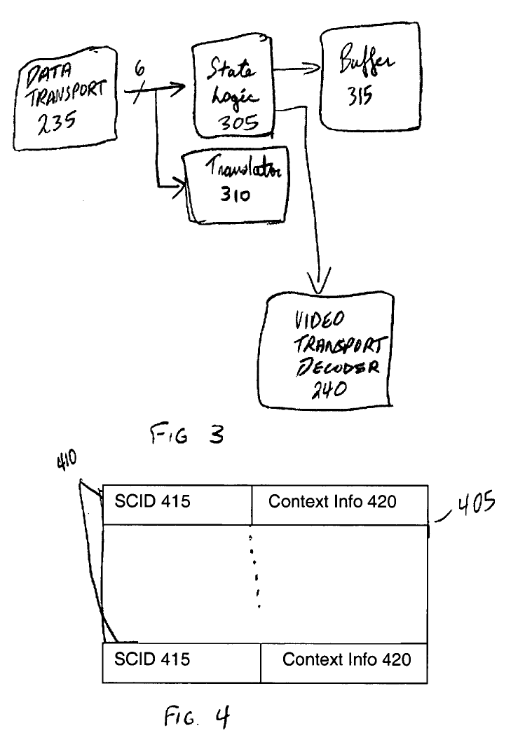

Referring now to FIG. 3, there is illustrated a block diagram of an exemplary video transport decoder 240. The video transport decoder 235 can handle multiple stream formats that include unbounded and bounded packetized elementary streams. There is a six-channel interface between the data transport 235 and the video transport decoder 240.

A translator 310 maps the six channels to three logical channels. The video transport decoder 240 includes a state machine 305 comprising logic to detect PES header 130a in incoming packetized elementary stream. The packetized elementary stream comes with a sync signal with the first byte of the PES start code 130a(1).

The state machine 305 can operate in one of two modes. In the default mode, the hardware breaks the PES into 130 byte-sized packets and sets a status flag to indicate whether there is a PES start code 130a(1) in the 130 byte sized packets. The packets are stored in a buffer 315. In the second mode of operation, the state machine 305 breaks the PES stream at the beginning of every PES start code 130a(1) and places each string in a different buffer 315.

The state machine 305 handles partial start codes which may straddle boundaries between two transport packets payload by postponing the transfer of the partial start code bytes and recording their status until the beginning of the next DirecTV transport packet payload. At the start of the next DirecTV transport packet payload, if the partial starcode bytes don't form a PES startcode, the partial startcode bytes are transferred to memory or discarded. If a PES start code is found, then the hardware interrupts the processor and the firmware goes ahead with the PES header parsing.

Upon detecting a PES start code 130a(1), the state machine 305 interrupts the video transport decoder 240. The video transport decoder 240 maintains the processing of each of the logical channels as a separate thread of operation. Each thread stops when a packet finishes and restarts at the beginning of the next packet with the same SCID 140b(1).

The state machine 305 also handles potential partial start codes (such as “00”, or “00 00”, or “00 00 01”). The state machine 305 aborts the transfer of the partial start code bytes and records the status until the beginning of the next packet. At the start of the next packet, if the partial start code bytes don't form a PES start code, the partial start code bytes are transferred to memory or discarded. If the partial start code bytes form a PES start code, then the state machine 305 interrupts the video transport decoder 240.

Responsive to receiving the interrupt, the video transport decoder 240 parses the PES header 130a and examines the SCID parameter 140b(1). The video transport decoder 240 looks up the SCID parameter 140b(1) in a context information table that correlates the SCID parameter 140b(1) to context information associated with the stream. The context information is then used during the thread for processing the PES.

Referring now to FIG. 4, there is illustrated a block diagram of an exemplary context information table 405. The context information table 405 includes records 410 comprising SCIDs 415 and context information 420, wherein the context information 420 is the context of the thread for the elementary stream associated with the SCID 415. When the video transport decoder 240 retrieves a SCID 140b(1) from a PES header 130a, the video transport decoder 240 determines the context associated with the SCID 140b(1) by looking up the SCID in the context information table 405. Upon finding a record 410 with the same SCID 415, the video transport decoder 240 retrieves and loads the context information 420 from the record 410. When the video transport decoder 240 finishes processing a packet, the video transport decoder 240 looks up the SCID in the context information table 405, retrieves a record 410 containing the same SCID 415 and replaces the context information 420 with the context when the decoder finishes processing the packet.

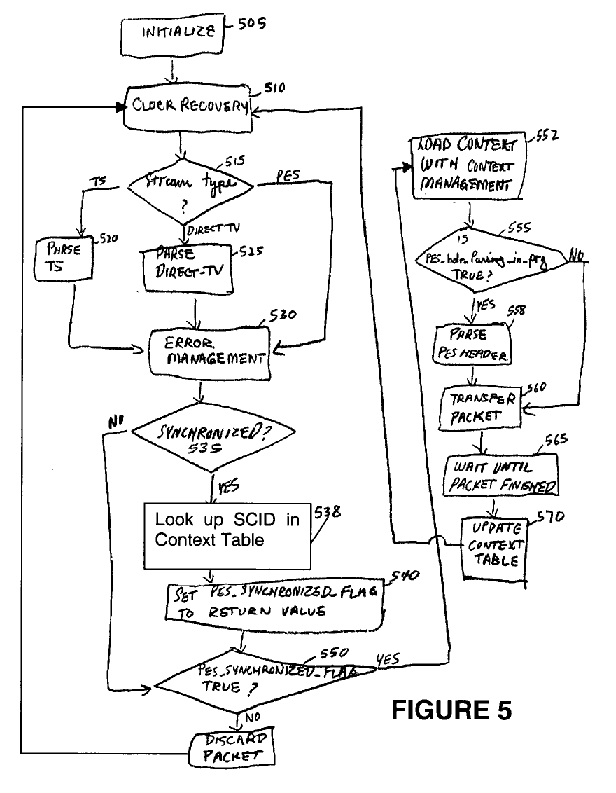

Referring now to FIG. 5, there is illustrated a flow diagram for processing packetized elementary streams in accordance with an embodiment of the present invention. At 505, the video transport decoder 240 initializes and clock recovery and pause/resume for playback occur at 510. At 515, the video transport decoder 240 determines the stream type that is received. If the stream type during 515 is a transport stream, the video transport decoder 240 parses 520 the transport stream header and an error management function is invoked at 530. If the stream is a Direct TV stream, the video transport decoder 240 parses 525 the Direct TV header and an error management function is invoked at 530. If the stream type is a PES, 520-530 are bypassed.

At 535 the video transport decoder 240 determines whether or not the stream is synchronized. If at 530, the stream is synchronized, the video transport decoder 240 looks up the SCID in the context table at 535 and during 540, the video transport decoder sets the PES_synchronized_flag to a return value. If the stream is not synchronized during 535, 538 and 540 are skipped.

At 550, a determination is made whether the PES_synchronized_flag is true. If at 550, PES_synchronized_flag is false, the packet is discarded and the next packet is examined (552) and 510 is repeated.

If at 550, the PES_synchronized_flag is true, the context associated with the SCID 140b(1) in the context table during 535 is loaded, using context management (552). At 555, a determination is made whether PES_hdr_Parsing_in_prg is true. If at 555, PES_hdr_Parsing_in_prg is true, the PES header 130a is parsed (558). If at 555, PES_hdr_Parsing_in_prg is false, 555 is bypassed. At 560, the packet transfer is initiated and at 565, the video transport decoder waits until the packet is finished. At the end of the packet, the context table is updated with the new context information (570) and 510 are repeated.

The decoder system as described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein the flow diagram of FIG. 5 is implemented in firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A system for processing packets, said system comprising:
state logic for detecting PES headers associated with the packets, the packets comprising DirecTV packets;
a processor for loading contexts responsive to the state logic detecting the PES headers; and
a buffer for storing the packets.

2. The system of claim 1, wherein the state logic interrupts the processor, responsive to detecting the PES headers.

3. The system of claim 1, wherein the packets comprise identifiers, and wherein the processor loads contexts associated with the identifiers.

4. The system of claim 3, wherein the processor stores contexts, responsive to detecting the end of the packets.

5. The system of claim 4, wherein the processor associates the stored contexts with the identifiers in the packets.

6. A system for processing packets, said system comprising:
state logic for detecting a packet header associated with a packet, wherein the packet comprises a DirecTV packet; and
a processor for loading a context associated with the packet;
the processor loading a first context if the packet is in a first group; and
the processor loading a second context if the packet is in a second group.

7. The system of claim 6, wherein the packet comprises an identifier, and wherein the processor loads the first context if the identifier is a first identifier and wherein the processor loads the second context if the identifier is a second identifier.

8. The system of claim 7, wherein the processor stores a third context responsive to detecting the end of the packet, and associates the stored context with the identifier.

9. A method for processing packets comprising:
detecting PES headers associated with the packets, the packets comprising DirecTV packets;
loading contexts responsive to the detecting the PES headers; and
storing the packets.

10. The method of claim 9, further comprising generating an interrupt, responsive to detecting the PES headers.

11. The method of claim 9, wherein the packets comprise identifiers, and wherein loading the contexts further comprises loading the context associated with the identifiers.

12. The method of claim 11, further comprising:
storing contexts, responsive to detecting the end of the packets.

13. The method of claim 12, further comprising associating the stored contexts with the identifiers in the packets.

14. A method for processing packets, said method comprising:
detecting a packet header associated with a packet, the packet comprising a DirecTV packet;
loading a first context if the packet is in a first group; and
loading a second context if the packet is in a second group.

15. The method of claim 14, wherein the packet comprises an identifier, and wherein the method further comprises:
storing a third context responsive to detecting the end of the packet; and
associating the stored context with the identifier.
